(19) United States
(12) Patent Application Publication
(10) Pub. No.: US 2003/0213240 A1
(43) Pub. Date: Nov. 20, 2003

(54) Hydraulic piston and cylinder assembly with improved equalization

(76) Inventors: Richard A. Nix, Ortonville, MI (US); Michael James Woodard, Utica, MI (US)

Correspondence Address: Thomas N. Young, Young & Basile, P.C., Suite 624, 3001 West Big Beaver Road, Troy, MI, 48084, US

(21) Appl. No.: 10/150,294

(22) Filed: May 17, 2002

(51) Int. Cl. B60T 11/26

(52) U.S. Cl. 60/588

(57) ABSTRACT

A hydraulic piston and cylinder assembly comprising a casing structure defining a reservoir port, a cylindrical bore, and an internal annular groove opening in the bore and communicating with the reservoir port; a piston slidably mounted in the bore for movement between a rearward retracted position in which the forward end of the piston is positioned proximate but forwardly of the internal groove and a forward extended position in which the forward end of the piston is positioned remotely forwardly of the internal groove, and an annular seal positioned in the internal groove and including an inner annular flexible lip sealingly and resiliently engaging the outer periphery of the piston as the piston moves between its retracted and extended positions. The piston includes an annular external groove proximate a forward end of the piston which, with the piston in its retracted position, is positioned in axial alignment with the seal and receives the inner annular lip of the seal with an annular space therebetween. The inner lip of the seal and the groove thus coact with the piston in its retracted position to define a fluid flow path interconnecting the reservoir port and the bore whereby to equalize the reservoir port and the bore.

### FIELD OF THE INVENTION

This invention relates to hydraulic piston and cylinder assemblies and more particularly to master cylinders especially suited for use in a master/slave hydraulic control system.

Master cylinders are in common usage such, for example, as in combination with a slave cylinder to provide the actuating mechanism for a mechanical clutch of a motor vehicle.

A typical master cylinder assembly includes a casing structure defining a cylindrical bore and a reservoir port, and a piston slidably mounted in the bore. Pressurized hydraulic fluid is discharged from the cylindrical bore for delivery to the slave cylinder in response to stroking reciprocal movement of the piston in the bore. Effective operation of the cylinder assembly requires the establishment of an effective seal between the piston and the bore of the cylinder. In one particularly effective cylinder assembly construction the seal comprises a stationary seal mounted in an internal grove in the casing structure. With this arrangement, it is imperative that some provision be made to provide fluid communication between the bore and the reservoir port with the piston in its retracted position so that the reservoir and bore may equalize to ensure that the bore of the casing is filled at all times. Prior art attempts to provide such equalization in stationary seal constructions have involved special and expensive machining operations with respect to the piston, thereby significantly increasing the overall cost of the cylinder assembly.

### SUMMARY OF THE INVENTION

This invention relates to an improved master cylinder for use in a master cylinder/slave cylinder assembly.

More particularly, this invention relates to a master cylinder of the stationary seal type wherein the piston has a simple, inexpensive construction but yet effectively provides equalization between the reservoir port and the cylinder bore.

The cylinder assembly of the invention is of the type comprising a casing structure defining a reservoir port, a cylindrical bore, and an internal annular groove opening in the bore and communicating with the reservoir port; a piston slidably mounted in the bore for movement between a rearward retracted position and a forward extended position; and an annular seal positioned in the internal groove and including an inner annular flexible lip sealingly and resiliently engaging the outer periphery of the piston as the piston moves between its retracted and extended positions.

According to the invention, the piston includes an annular external depression which, with the piston in its retracted position, is positioned in axial alignment with the seal and receives the inner annular lip of the seal with an annular space therebetween. This arrangement allows the provision of equalization between the reservoir port and the cylinder bore without the need for further machining steps beyond the steps required to form the piston.

According to a further feature of the invention, the inner lip portion of the seal is resiliently deflected as the piston moves in the bore from the extended to the retracted position but is relaxed and unstressed when received in the annular external depression. This arrangement allows the seal to remain in an unstressed condition during the rest or retracted position of the piston whereby to enhance the overall effective life of the seal.

According to a further feature of the invention, the annular external depression comprises an annular external groove. This specific construction is readily provided in the fabrication of the piston and provides piston stability.

According to a further feature of the invention, with the piston in the retracted position, a recuperative hydraulic fluid flow path is defined between the forward end of the piston and the grooves. This arrangement allows the completion of a clear fluid path between the cylinder bore and the reservoir port for equalization purposes.

According to a further feature of the invention, the casing defines an annular shoulder defining a forward end of the internal groove and an annular casing lip projecting rearwardly from the shoulder into the internal groove; the annular casing lip is crenellated and coacts with the seal to define a plurality of circumferentially spaced crenel passages therebetween providing fluid communication between the reservoir port and the bore; and the seal further includes an outer annular flexible lip moveable in response to variations in fluid pressure between an outwardly flexed position blocking fluid communication between the reservoir port and the crenel passages and an inwardly flexed position allowing fluid communication between the reservoir port and the crenel passages and thereby between the reservoir port and the bore. This arrangement allows the seal to provide a recuperative fluid flow to the bore forwardly of the retreating position.

According to a further feature of the invention, the casing comprises a two part structure including a molded front part and a molded rear part; the front and rear parts include coacting means for joining the parts in a configuration in which the front part defines a forward bore portion and the rear part defines a rearward bore portion; and the parts coact to define the internal annular groove. This arrangement provides a ready and convenient means of defining the internal groove for receiving the seal.

According to a further feature of the invention, the annular seal comprises a primary seal; the piston and cylinder assembly further includes a second annular seal positioned in the annular internal groove rearwardly of the primary seal and rearwardly of the reservoir port; the piston and cylinder assembly further includes an annular spacer positioned in the annular internal groove between the primary seal and the secondary seal proximate the reservoir port; and the spacer provides passage means allowing for passage of fluid therethrough. This arrangement allows the use of primary and secondary seals to provide effective sealing action between the cylinder bore and the piston, while yet retaining adequate equalizing fluid flow between the reservoir port and cylinder bore.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a cross sectional view of a master cylinder according to the invention;

FIG. 2 is a cross sectional view taken on the line 2-2 of FIG. 1 and omitting a primary seal for purposes of clarity;

FIG. 3 is a detail view taken within the circle 3 of FIG. 1;

FIG. 4 is an exploded view of a casing structure utilized in the invention master cylinder;

FIGS. 5, 6 and 7 are detail views of a spacer utilized in the master cylinder;

FIG. 8 is a detail view taken within the circle 8 of FIG. 1; and

FIG. 9 illustrates an alternate embodiment of the invention.

### DESCRIPTION OF THE PREFERRED EMBODIMENT

The master cylinder 10 of the invention may be utilized in a master/slave cylinder hydraulic system where it is desired to deliver pressurized fluid from a master cylinder in response to operator input via a piston rod for delivery to a slave cylinder which functions to perform a work operation. The master cylinder of the invention may be used, for example, in a motor vehicle clutch system wherein a clutch pedal of the vehicle is utilized to actuate the master cylinder to deliver pressurized fluid to a slave cylinder to engage and disengage the clutch.

The master cylinder 10 of the invention, broadly considered, includes a casing structure 12, a piston 14, a piston rod assembly 16, a seal assembly 18, and a spring 22.

Casing structure 12 includes a front body 24 and a rear piston retainer part 26 both formed by injection molding a suitable plastic material such as glass reinforced nylon.

Body 24 has a generally tubular configuration and includes a main body portion 24a, a forward fitting portion 24b, and an enlarged rear portion 24c. Main body portion 24a defines a central bore 24d, fitting portion 24b defines a central bore 24e communicating with bore 24d via a port 24f extending through a forward end wall 24g, and rear portion 24c defines a bore 24h opening at the rearward annular end 24i of the rear portion. An annular shoulder 24j interconnects bore 24d and bore 24h and an annular lip 24k projects rearwardly from shoulder 24j. Annular lip 24k includes a plurality of circumferentially spaced cutouts 241 giving the lip a crenelated or castellated configuration including circumferentially spaced land portions 24m alternating with grooves or passages 24n. A plurality of axially extending circumferentially spaced radially inwardly opening grooves 24p are optionally provided in bore 24d and extend from shoulder 24j forwardly to a juncture with a respective plurality of circumferentially spaced ribs 24q projecting forwardly from wall 24g proximate the forward end of bore 24d.

Body 24 further includes annular external mounting flanges 24r and 24s to facilitate mounting of the casing to the associated motor vehicle structure, a plurality of circumferentially spaced rectangular openings 24t positioned in rear portion 24c proximate annular rear end 24i, and a spigot or fitting 24u defining an angled central reservoir bore 24v opening at port 24w in bore 24h and arranged for communication with a suitable reservoir (not shown) for containing hydraulic fluid.

Piston retainer 26 has a generally tubular configuration and includes a forward portion 26a defining an internal forwardly opening groove 26b and an external groove 26c receiving an “O” ring 28, a rear main body portion 26d defining a cylindrical bore 26e and including a rear wall 26f defining a central opening 26g; and a plurality of circumferentially spaced spring fingers or prongs 26h extending rearwardly from an annular shoulder 26i interconnecting portions 26a and 26d.

Piston 14 may be formed of a suitable plastic, aluminum, or other metal material and includes a forward portion 14a defining a blind forwardly opening central bore 14b and a rearward portion 14c defining a blind rearwardly opening central bore 14d. A solid partition 14e separates bores 14b and 14d and an annular external depression 14f is provided proximate but spaced rearwardly from the forward annular end 14g of the piston. The forward annular shoulder 14h defining depression 14f may form an angle of 45 degrees with respect to the central axis of the piston, the rearward annular shoulder 14i defining depression 14f may form an angle of 30 degrees with respect to the central axis of the piston, and the bottom wall 14j of depression 14f may extend generally parallel to the central axis of the piston. The outer periphery of piston 14 has a purely cylindrical geometry generally conforming to the geometry of the cylindrical bores 26d and 26e.

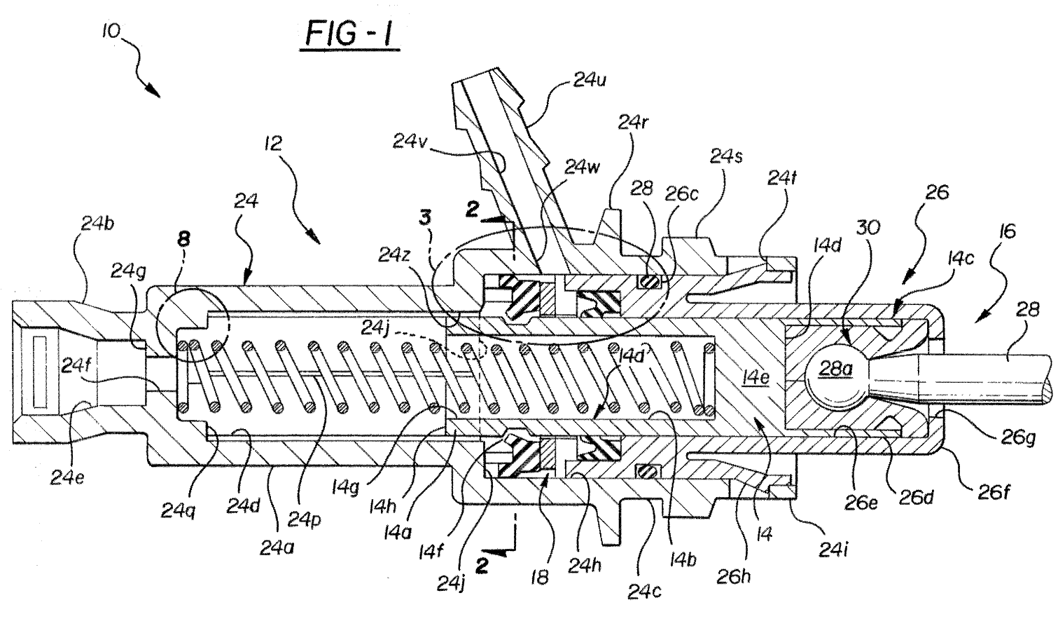

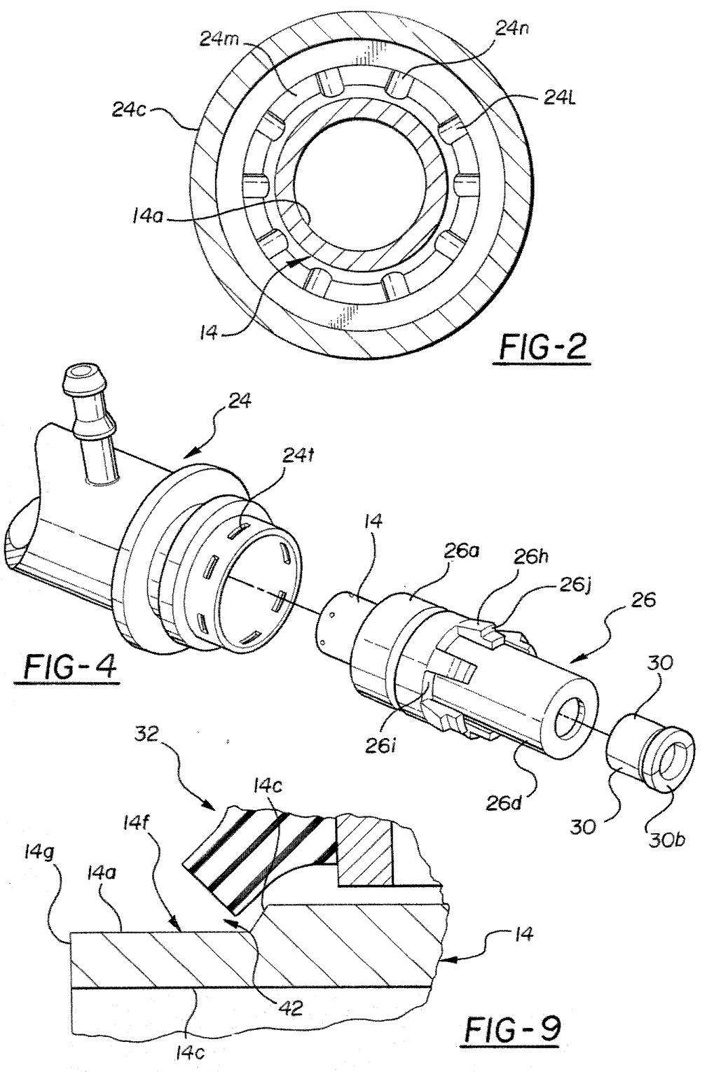

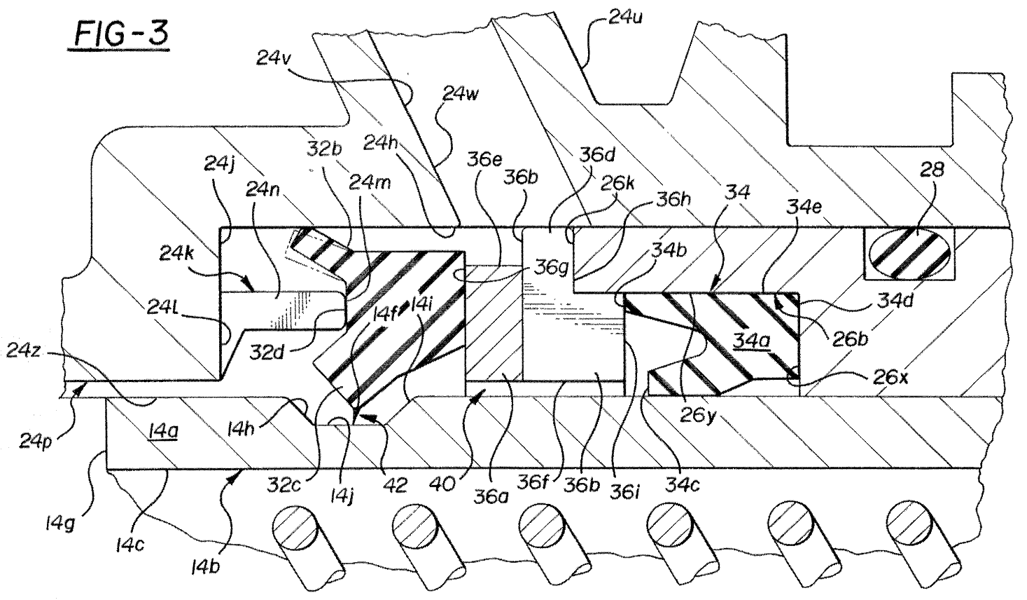

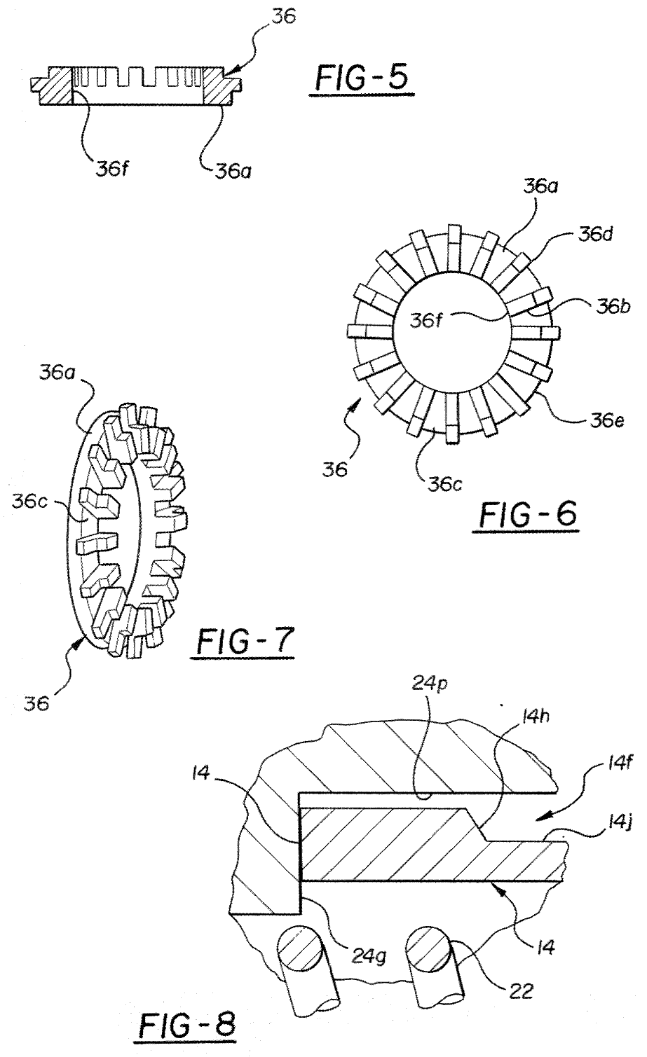

It will be appreciated that the outer peripheral portion of piston 14 to the left of the depression 14f in FIGS. 1 and 3 is non-essential and, although it provides stability, may be omitted as shown in the alternate embodiment of the invention seen in FIG. 9. In this alternate embodiment, the depression 14f has no forward shoulder so that the depression extends forwardly to the forward annular end 14g of the piston. When the forward shoulder is present as in the embodiment of FIGS. 1 and 3, the depression 14f takes the form of an annular external groove.

Piston rod assembly 16 includes a piston rod 28 and piston rod retainers 30. Piston rod 28 is of known form and is intended for coaction at its rearward end, for example, with a clutch pedal of a motor vehicle. The forward end of the piston rod has a ball configuration 28a. Piston rod retainers 30 are designed to coact to encapsulate the ball 28a of the piston rod and have cylindrical configurations sized to fit within blind bore 14d with the ball 28a of the piston rod entrapped therebetween.

Seal assembly 18 includes a primary seal 32, a secondary seal 34, and a spacer 36.

Primary seal 32 is formed of a suitable elastomeric material such for example as EPDM material and has an annular configuration. Seal 32 includes an annular main body portion 32a, an outer lip portion 32b, and an inner lip portion 32c. Outer lip portion 32b has a thinner cross sectional configuration than inner lip portion 32c so as to be more readily flexed.

Secondary seal 34 is also formed of a suitable elastomeric material such for example as EPDM and has an annular configuration. Secondary seal 34 includes a main body portion 34a, and outer lip portion 34b, and an inner lip portion 34c.

Spacer 36 has an annular configuration and is formed of a suitable plastic material in a suitable molding operation. Spacer 36 includes an annular main body portion 36a and a plurality of circumferentially spaced lug portions 36b projecting rearwardly from a rear face 36c of the main body portion and each including a crenel portion 36d projecting radially outwardly beyond the outer periphery 36e of the main body portion to provide a castellated or crenellated configuration to the outer periphery of the spacer. The outer diameter of the spacer as defined by the radially outwardly projecting crenel portions 36d corresponds generally to the diameter of bore 24h of the rear portion of the body of the casing structure and the inner diameter 36f of the spacer is somewhat larger than the diameter of piston 14 so that piston 14 does not contact spacer inner diameter 37f.

Spring 22 is formed of a suitable metallic material and has a known coil configuration.

### Assembly

In the assembled configuration of the master cylinder, piston retainer 26 is telescopically received in bore 24h and is locked in position within the body by the engagement of shoulders 26j defined on fingers 26h against the rearward edges of openings 24t; piston 14 is slidably received in bores 24d and 24e; piston rod retainers 30 are positioned in blind bore 14d; piston rod 28 extends through opening 26g with its spherical forward end 28a encapsulated by retainers 30; primary seal 32 is positioned in bore 24h with outer lip 32b flexibly and sealingly engaging bore 24h, inner lip 32c adapted to flexibly and sealingly engage the outer periphery of piston 14, and a crotch 32d defined between inner and outer lips 32b and 32c seated against the land portions 24m of lip 24k; spacer 36 is positioned in bore 24h against primary seal 32 with the forward annular face 36g of main body portion 36a seated against rear annular face 32e of the main body portion 32a of primary seal 32, the outer diameter of crenels 36d seated in bore 24h in axial alignment with reservoir port 24w, inner diameter 36f positioned in outwardly spaced relation to the outer diameter of piston 14 to define an annular passage 40 between the piston and the spacer, and the rearward face 36h of crenels 36d seated against the annular forward edge 26k of piston retainer 26; secondary seal 34 is positioned in groove 26b with the rear annular face 34d of the main body of the seal seated against an annular shoulder 26x defining the rearward extent of groove 26b, the outer face 34e of the main body of the seal positioned against surface 26y defining the outer periphery of groove 26b, outer lip 34b flexibly and sealingly positioned in the juncture between the rearward face 36i of the spacer lugs 36b and the surface 26y, and inner lip 34c flexibly and sealingly engaging the outer periphery of piston 14; and spring 22 is positioned at its rearward end in blind bore 14b and at its forward end against end wall 24g to resiliently maintain the piston in a rearwardly retracted position wherein the annular rear surface 30b of piston rod retainers 30 engage wall 26f, depression 14f is positioned immediately under the sealing line on the piston of inner lip 32c of the primary seal, the rear portion of the piston is slidably received in bore 26e, and the forward end 14g of the piston is slidably received in a rear section 24z of bore 24d. It will be seen that body 24 and piston retainer 26 coact to define a casing structure having a central bore defined by bores 24d/26e, and that surfaces 24j, 24h, 26k, 26y and 26x combine in the assembled master cylinder to define an annular internal groove positioned in surrounding relation to the bore 24d/26e between the ends of the bore in which the primary seal, spacer, and secondary seal are positioned in surrounding relation to the piston.

### Operation

With the piston in the fully retracted position seen in FIG. 1, it will be seen that the piston external groove 14f is positioned in axial alignment with seal 32 with the inner lip portion 32c of the seal received in groove-like relief 14f in radially outwardly spaced relation to the bottom wall 14j of the relief to define an annular passage 42 therebetween. The reservoir port 24v and the bore of the casing are thus fluidly connected by bore 24v, spaces between the crenels of the spacer, passage 40, passage 42, and axial bore grooves 24p so that the reservoir and casing structure may equalize to ensure that the bore of the casing is filled at all times. The described fluid passage between the reservoir and the bore of the cylinder also facilitates initial filling of the cylinder.

When the piston is moved forwardly in the cylinder in response to, for example, depression of the clutch pedal of the associated motor vehicle, the rearward annular shoulder 14i of relief 14f immediately deflects the inner lip 32c of primary seal 32 outwardly and the piston moves forwardly beyond the effective sealing edge of the inner lip 32c so that communication between the reservoir and the bore of the cylinder is terminated and so that, as the piston continues to move forwardly, the fluid forwardly of the piston is pressurized for delivery to the slave cylinder and ultimate actuation of the associated clutch of the motor vehicle.

The forward movement of the piston is resisted by compression of the spring 22 and the forward or extended position of the piston is defined, as seen in FIG. 8, by engagement of the annular front edge 14g of the piston with ribs 24q.

It will be seen that as the piston moves from its retracted to its extended position the front end of the piston is at all times firmly guided by bore 24d and the rear end of the piston is at all times firmly guided by bore 26e.

In a normal retraction of the piston wherein the operator's foot remains on the clutch pedal and allows the system to gradually return to a retracted position, fluid from the slave cylinder and the interconnecting conduit flow into the bore 24d behind the retreating piston to ensure that the bore remains filled.

However, in certain situations such as when the operators foot slips off the clutch pedal and the pedal and the piston are returned abruptly to the retracted position, the fluid from the slave cylinder and conduit are unable to in effect keep up with the retreating piston to fill the bore behind the retreating piston. In this case, it is necessary to allow the reservoir to replenish or recoup the cylinder. This recouping flow is allowed by radially inward flexing movement of the outer lip of the primary seal to the dash line position seen in FIG. 3 so as to create a passage from port 24w around the outer periphery of the primary seal, around the inwardly flexed lip 32b, through the crenel passages 24n, and through the axial bore grooves 24p.

The use of an external depression or groove at the forward end of the piston for coaction with the inner lip of the primary seal allows the necessary equalization between the reservoir and the cylinder bore to be achieved utilizing an extremely simple and extremely inexpensive piston construction. Specifically, the depression or groove may be provided in the same screw machine operation by which the basic piston structure is formed, thereby eliminating the need to provide a further piston forming operation to provide, for example, a series of circumferentially spaced external axial grooves in the piston proximate the seal. The use of the external depression or groove further allows the inner lip of the seal, with the piston and cylinder assembly in the retracted at rest position, to assume a relaxed unstressed configuration, thereby prolonging seal life.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A hydraulic piston and cylinder assembly comprising a casing structure defining a reservoir port, a cylindrical bore and an internal annular groove opening in the bore and communicating with the reservoir port; a piston slidably mounted in the bore for movement between a rearward retracted position and a forward extended position; and an annular seal positioned in the internal groove and including an inner annular flexible lip sealingly and resiliently engaging the outer periphery of the piston as the piston moves between its retracted and extended positions; characterized in that:
the piston includes an annular external depression which, with the piston in its retracted position, is positioned in axial alignment with the seal and receives the inner annular lip of the seal with an annular space therebetween.

2. A piston and cylinder assembly according to claim 1 wherein the inner lip portion of the seal is resiliently deflected as the piston moves in the bore from the extended to the retracted position but is relaxed and unstressed when received in the external piston depression.

3. A piston and cylinder assembly according to claim 2 wherein, with the piston in the retracted position, a recuperative hydraulic fluid flow path is defined.

4. A piston and cylinder assembly according to claim 1 wherein the annular external depression comprises an annular external groove.

5. A hydraulic piston and cylinder assembly comprising a casing structure defining a reservoir port, a cylindrical bore, and an internal annular groove opening in the bore and communicating with the reservoir port; a piston slidably mounted in the bore for movement between a rearward retracted position and a forward extended position; and an annular seal positioned in the internal groove and including an inner annular flexible lip sealingly and resiliently engaging the outer periphery of the piston as the piston moves between its retracted and extended positions; characterized in that:
the piston includes an annular external depression axially aligned with the seal lip with the piston in its retracted position;
with the piston in its retracted position, a recuperative hydraulic fluid flow path is defined between the forward end of the piston and the groove; and
the depth and width of the annular external depression is such that, with the piston in its retracted position, the inner seal lip is positioned in the annular external depression in radially outwardly spaced relation to the bottom of the annular external depression to define an annular passage therebetween, whereby the reservoir port and bore are fluidly interconnected by the recuperative path and the annular passage so that the reservoir port and bore may equalize to ensure that the bore is filled at all times.

6. A piston and cylinder assembly according to claim 5 wherein the inner lip portion of the seal is resiliently deflected as the piston moves in the bore from the extended to the retracted position but is relaxed and unstressed when received in the annular external depression.

7. A piston and cylinder assembly according to claim 6 wherein the casing defines an annular shoulder defining a forward end of the internal groove and an annular casing lip projecting rearwardly from the shoulder into the internal groove for engagement with a forward annular face of the annular seal.

8. A piston and cylinder assembly according to claim 7 wherein:
the casing comprises a two part structure including a molded front part and a molded rear part;
the front and rear parts include coacting means to join the parts in a configuration in which the front part defines a forward bore portion and the rear part defines a rearward bore portion, and the parts collective define the internal annular groove.

9. A piston and cylinder assembly according to claim 8 wherein:
the annular seal comprises a primary seal; and
the piston and cylinder assembly further includes a secondary annular seal positioned in the annular internal groove rearwardly of the primary seal and rearwardly of the reservoir port.

10. A piston and cylinder assembly according to claim 9 wherein:
the piston and cylinder assembly further includes an annular spacer positioned in the annular internal groove between the primary seal and the secondary seal proximate the reservoir port; and
the spacer provides passage means allowing the passage of fluid therethrough.

11. A piston and cylinder assembly according to claim 5 wherein the annular external depression comprises an annular external groove.

12. A hydraulic piston and cylinder assembly comprising:
a casing structure defining a reservoir port, a cylindrical bore, and an internal annular groove opening in the bore and communicating with the reservoir port;
a piston having an external annular groove proximate a forward end thereof and slidably mounted in the bore for movement between a rearward retracted position in which the piston external groove is positioned in axial alignment with the internal groove and a forward extended position in which the forward end of the piston is positioned remotely forwardly of the internal groove; and
an annular seal positioned in the internal groove and including an inner annular flexible lip sealingly and resiliently engaging the outer periphery of the piston as the piston moves between its retracted and extended positions and received in the piston external groove with the piston in its retracted position with an annular space defined between the lip and the external groove to provide equalizing flow between the bore and the reservoir port.

13. A piston and cylinder assembly according to claim 12 wherein the inner lip portion of the seal is resiliently deflected as the piston moves in the bore from the extended to the retracted position but is relaxed and unstressed when received in the external piston groove.

14. A piston and cylinder assembly according to claim 13 wherein, with the piston in the retracted position, a recuperative hydraulic fluid flow path is defined between the forward end of the piston and the grooves.
